(19) United States
(12) Patent Application Publication
(10) Pub. No.: US 2012/0184689 A1
(43) Pub. Date: Jul. 19, 2012

(54) Stationary phase composition for chromatographic separation and method for preparing same

(76) Inventors: Hsi-Ya Huang, Zhongli City (TW); Yi-Jie Cheng, Zhongli City (TW); Chao-Hsiang Hsu, Zhongli City (TW); Wan-Ling Liu, Zhongli City (TW); Yi-Fen Hsu, Zhongli City (TW); Cheng-Lan Lin, Zhongli City (TW); Sze-Tsen Lee, Zhongli City (TW)

(21) Appl. No.: 13/210,729

(22) Filed: Aug. 16, 2011

(30) Foreign Application Priority Data
Jan. 13, 2011 (TW) 100101549
Apr. 14, 2011 (TW) 100112949

(51) Int. Cl. C08G 77/38

(52) U.S. Cl. 525/479

(57) ABSTRACT

The present invention relates to a stationary phase composition. The composition comprises a support material, on which at least a divinylbenzene group and an acrylic group, and optionally a styrene group, are provided. Preferably, the acrylic group has an alkyl moiety of at least 4 carbon atoms. The composition can serve as a monolithic column for chromatographic separation. The composition exhibits an altered π-π interaction with aromatic compounds, whereby the peak symmetry of aromatic compounds is improved during separation, the separation time is shortened and the occurrence of peak-overlapping and peak-tailing is prevented.

### CROSS-REFERENCE TO RELATED APPLICATION

The present invention claims priority to Taiwanese Patent Application No. 100101549 filed Jan. 13, 2011, and Taiwanese Patent Application No. 100112949 filed Apr. 14, 2011, the entirety of each of which is hereby incorporated by reference.

### BACKGROUND OF THE INVENTION

1. Field of the Invention

The present invention relates to a stationary phase composition and a method for preparing the same. When used for chromatographic separation, the stationary phase composition disclosed herein is shown capable of reducing separation time and improving the so-called peak-tailing problem.

2. Description of the Prior Art

Since chromatography was developed some eighty years ago, it has become one of the most efficient tools for separating chemicals. In addition to serving as a tool for isolating various organic compounds, chromatography is effective in quantitative and qualitative characterization of compounds. Compared to the traditional purification processes, such as distillation,re-crystallization,extraction and sublimation, chromatography is advantageous in low sample consumption, high speed, convenience, high safety and excellent efficiency.

From the technique point of view, chromatography is carried out by virtue of separating the compound to be measured from other molecules in a mixture based on differential partitioning between the stationary and mobile phases. Based upon the mechanism of separation, chromatography can be roughly classified into gas chromatography and liquid chromatography, while liquid chromatography can be further classified as thin layer chromatography (TLC), column chromatography (CC), paper chromatography (PC) and high performance liquid chromatography (HPLC).

The so-called column chromatography is performed by packing an adsorptive solid material (such as silica gel and alumina) soaked by an eluent into an erected glass tube to serve as a stationary phase, then loading a mixture onto the top of the packed column, and utilizing the eluent as an mobile phase to separate the compounds of interest from the other molecules in the mixture by taking advantage of differential retention of compounds on the stationary phase due to the differences between the adsorption force of the compounds to the stationary phase and the solubility of the compounds in the eluent.

The separation efficiency of column chromatography is affected by many factors, including the material of the stationary phase, the diameter/length ratio of the column, the packing quality of the column, the polarity of the column, the elution rate, the loading of samples and the collection of eluates. It has been reported in literature that polystyrene-based stationary phase materials are very useful in HPLC and capillary electrochromatography (CEC) for isolation of mega-molecules, such as proteins, proteomes and peptides, and small analytes, such as hormones, anilines, alkyl benzenes and aromatic compounds. Especially when these materials are used in CEC, they have attracted a great deal of attention in this era of pursuing efficiency and environmental protection, because of their advantages in low sample and solvent consumption and high separation efficiency.

According to the mechanism of chromatographic separation using CEC, the separation efficiency of a polystyrene-based monolithic column can be enhanced by varying the porosity of its stationary phase by adjustment of reaction time, monomer's proportions and types and ratios of porogenic solvents during the polymerization, thereby increasing the total surface area of the stationary phase. However, the separation of some analytes can scarcely be improved upon by varying the porosity of the stationary phase. A polystyrene copolymer-based stationary phase is able to be directly employed in reversed-phase chromatography due to its high hydrophobicity, but it would face some problems during CEC separation when the substances to be analyzed are of extreme hydrophobicity or of hydrophilic property. This is because hydrophilic analytes only exhibit weak interaction with the hydrophobic stationary phase. As a result, hydrophilic analytes will be rapidly eluted out from the column by the mobile phase and demonstrate a low partition coefficient to the stationary phase and a poor separation effect. On the contrary, when the analytes are highly hydrophobic and tend to strongly interact with the hydrophobic stationary phase, the extremely high partition coefficients of the analytes to the stationary phase cause overly excess retention of analytes in the column and a serious peak-tailing problem.

Therefore, there is need in the art for a stationary phase composition suitable for chromatographic separation of analytes which are either of hydrophilicity or extremely high hydrophobicity, or of similar structures or sizes. Advantageously, such stationary phase composition can lead to a satisfactory separation effect and a reduced separation time and further overcome the peak-overlapping and peak-tailing problems.

### SUMMARY OF THE INVENTION

Accordingly, an object of the invention is to provide a stationary phase composition which can lead to a reduced separation time without the occurrence of the peak-overlapping and peak-tailing problems in a chromatographic separation process.

In order to achieve this object, the inventive stationary phase composition comprises a support material, on which at least a divinylbenzene group and an acrylic group, and optionally a styrene group, are provided. Preferably, the acrylic group has an alkyl moiety of at least 4 carbon atoms.

The inventive stationary phase composition can serve as a monolithic column for chromatographic separation. According to the invention, it is believed that the strength of π-π interaction between the inventive stationary phase composition and aromatic compounds is altered, whereby the peak symmetry of aromatic compounds is improved during separation, the separation time is shortened and the occurrence of peak-overlapping and peak-tailing is prevented.

Another object of the invention is to provide a method for preparing a stationary phase composition, comprising the steps of:

(a) modifying a capillary column with a silane coupling agent having an acrylic group; and

(b) introducing a monomer mixture of a divinylbenzene monomer and an acrylic monomer and a solvent into the capillary column and allowing them to react under a predetermined reaction condition. Preferably, the solvent is a porogenic solvent and the monomer mixture further comprises a styrene monomer.

### BRIEF DESCRIPTION OF THE DRAWINGS

The above and other objects, features and effects of the invention will become apparent with reference to the following description of the preferred embodiments taken in conjunction with the accompanying drawings, in which:

FIGS. 1A-C are diagrams showing the variation in tailing factor and resolution of analytes versus the LMA-styrene ratios of the stationary phase compositions used for chromatographic separation of the analytes according to Embodiment 1 of the invention;

FIGS. 2A-D are diagrams showing the variation in retention time of analytes versus the LMA-styrene ratios of the stationary phase compositions used for chromatographic separation of the analytes according to Embodiment 1 of the invention;

FIGS. 3A-C are diagrams showing the variation in retention time of analytes versus the styrene-DVB-BMA ratios of the stationary phase compositions used for chromatographic separation of the analytes according to Embodiment 2 of the invention;

FIGS. 4A-D are diagrams showing the variation in retention time of analytes versus the styrene-DVB-(BMA, OMA, LMA) ratios of the stationary phase compositions used for chromatographic separation of the analytes according to Embodiment 2 of the invention;

FIG. 5 is a schematic diagram illustrating the π-π interaction between analytes and a poly(S-DVB) nodule;

FIG. 6 is a schematic diagram illustrating the π-π interaction between analytes and a poly(DVB-LMA) nodule;

FIGS. 7A-B are diagrams showing the variation in retention time of analytes versus the porogenic solvent composition according to Embodiment 2 of the invention; and

FIGS. 8A-D are diagrams showing the optimization of polymerization reaction time, SMA ratio, monomer content and reaction temperature according to Embodiment 3 of the invention.

### DETAILED DESCRIPTION OF THE INVENTION

The stationary phase composition disclosed herein comprises a support material, on which at least a divinylbenzene group and an acrylic group are provided. The divinylbenzene group is selected from the group consisting of an ortho-divinylbenzene group and the derivatives thereof, a meta-divinylbenzene group and the derivatives thereof, a para-divinylbenzene group and the derivatives thereof, and any combination thereof. Preferably, a styrene group is further provided on the support material. Preferably, the acrylic group has an alkyl moiety of at least 4 carbon atoms. The inventive stationary phase composition can serve as a monolithic column for chromatographic separation. According to the invention, the mobile phase comprises acetonitrile (ACN) in an aqueous solution. In a preferred embodiment, mobile phases are prepared by mixing acetonitrile and a phosphate buffer (5 mM) in different volume ratios. 1M HCl or NaOH is then added to the mobile phase solutions until the desired pH is achieved.

Preferably, the acrylic group having an alkyl moiety of at least 4 carbon atoms is derived from a methacrylate monomer, such as butyl methacrylate (BMA), octyl methacrylate (OMA), laurylmethacrylate (LMA) and stearyl methacrylate (SMA) having a straight alkyl moiety of 4, 8, 12 and 18 carbon atoms, respectively, and a combination thereof. In some embodiments, the methacrylate monomer is mixed with a divinylbenzene monomer and/or a styrene monomer to form a monomer mixture, to which a porogenic solvent is further added. Based on the combined volume of the monomer mixture and the porogenic solvent, the monomer mixture is preferably present in an mount of 10%˜50% by volume and the porogenic solvent is in an amount of 50%˜90% by volume. The polymerization reaction is allowed to carried out under a predetermined reaction condition with a reaction temperature of 0˜80° C., preferably 50˜80° C., for a reaction time of 1˜24 hours. The polymeric stationary phase composition thus prepared exhibits an altered π-π interaction with aromatic compounds, whereby the peak symmetry of aromatic compounds is improved during separation, the separation time is shortened and the occurrence of peak-overlapping and peak-tailing is prevented.

The following Examples are given for the purpose of illustration only and are not intended to limit the scope of the present invention.

### DETAILED DESCRIPTION OF THE PREFERRED EMBODIMENTS

The examples described below are carried out using the following apparatuses. The CEC experiments were performed with a Beckman Coulter MDQ capillary electrophoresis system equipped with a photodiode array detector (Fullerton, Calif., USA). Beckman Coulter MDQ 32 Karat software was used for instrumental control and data analysis. A Waters instrument model 515 HPLC pump (Milford, Mass., USA) was used for washing and equilibrating the polymeric monolithic column. A scanning electron microscope model Hitachi S-4100 (Ibraraki, Japan) was used for the polymeric morphology observation. A surface area analysis equipment model Micromeretics Tri-star 3000 (Norcross, Ga., USA) was employed for surface area measurement. A thermo Nexus 6700 FT-IR spectrometer (Waltham, Mass., USA) was used to detect exposed functionalities. A thermogravimetry model TG/DTA 6200 from SII Nano Technology (Chiba, Japan) was used for thermal decomposition temperature (Td) measurement. A mercury intrusion porosimeter model Micromeretics Autopore IV 9500 (Norcross, Ga., USA) was used for pore size measurement.

The monolithic columns used in the examples below are prepared according to the following procedure. First, a support material, which is in the form of a capillary column made of silicone material and having an inner wall of a 100 μm I.D. is subjected to a pretreatment. The capillary is conditioned by washing with 0.1M sodium hydroxide for 5 minutes, followed by deionized water for 20 minutes and finally with methanol for 5 minutes. After the capillary is dried by N₂ gas, it is filled with and modified by 3-(trimethoxysilyl)-1-propyl methacrylate (MSMA) mixed with methanol. The methoxy group (—OCH₂) present in MSMA is reacted with the silanol functionality on the inner wall of the capillary through a hydrolysis and condensation reaction. As a result, a —Si—O—Si—C— linkage is created and a vinyl functionality (—C═CH₂) is exposed to make the capillary possible to react with monomers in subsequent procedures for preparing the stationary phase. Both ends of the capillary are sealed and submerged in a 35° C. water bath for 17 hours. Afterwards, the capillary is washed with methanol for 13 minutes, then with de-ionized water for 13 minutes, and dried with N₂ gas.

### Embodiment 1

This embodiment involves a capillary electrochromatographic (CEC) process using copolymers of styrene, divinylbenzene and lauryl methacrylate as stationary phase compositions for separation of five synthetic antioxidants through step-gradient elution.

2,6-di-tert-butyl-4-methyl phenol (BHT), butylated hydroxyanisole (BHA), tert-butylhydroquinone (TBHQ), propyl gallate (PG) and octyl gallate (OG) are common synthetic antioxidants. In the United States, the allowable quantity of each of these antioxidants to be added to food products is strictly regulated by the Food and Drug Administration (FDA), with a maximum allowable quantity around 200 ppm. It has been reported in literature that some synthetic antioxidants, after being absorbed by human body, could be converted into toxic substances and cause damage to human body, and that some synthetic antioxidants are shown to increase the risk of carcinogenic events in animal experiments. Therefore, a continuous monitoring of the contents of synthetic antioxidants in food products is necessary for human health. The antioxidant standards used as test analytes in this embodiment are individually prepared by dissolving 0.04 g of each antioxidant standard in 20 mL methanol to constitute a stock solution at a concentration of 2000 μg/mL. The stock solutions are diluted with acetonitrile to appropriate concentrations prior to use.

TABLE 1

| | Monomer mixture | | | Porogenic solvent 76% (v/v) | | |
|---|---|---|---|---|---|---|
| | 24% (v/v) | | | Cyclo- | | |
| | LMA | Styrene | DVB | hexanol | DMAc | water |
| | % (v/v) | % (v/v) | % (v/v) | % (v/v) | % (v/v) | % (v/v) |
| Example 1 | 0 | 40 | 60 | 47.5 | 47.5 | 5 |
| Example 2 | 20 | 20 | 60 | 47.5 | 47.5 | 5 |
| Example 3 | 30 | 10 | 60 | 47.5 | 47.5 | 5 |
| Example 4 | 40 | 0 | 60 | 47.5 | 47.5 | 5 |

After conditioning the inner wall of each capillary, monomer mixtures are prepared according to Examples 1˜4 listed in Table 1 above and dissolved in the porogenic solvent. The resultant solutions are mixed with a charged monomer present in an amount of 2 wt %˜2.6 wt % based on the total weight of monomers (preferably, 0.0448 g vinylbenzenesulfonic acid, VBSA) and an initiator in an amount of 0.7 wt %˜0.9 wt % based on the total weight of monomers (preferably, 0.0155 g 2,2′-azobisisobutyronitrile, AIBN). Each of the mixtures thus obtained is sonicated for 15 minutes and then filled into a preconditioned capillary (having an overall length of 33 cm) to a length of 20 cm. After both ends of the capillary are sealed with an adhesive resin, the capillary is submerged in a 70° C. water bath for 15 hours.

According to Table 1, monolithic columns are each manufactured using a monomer mixture in an amount of 24% by volume and a porogenic solvent in an amount of 76% by volume. The monomer mixture includes a styrene monomer in an amount of 0%˜40% by volume, a divinylbenzene (DVB) monomer in an amount of 50%˜80% by volume, and lauryl methacrylate (LMA) monomer in an amount of 0%˜40% by volume . The porogenic solvent comprises cyclohexanol in an amount of 40%˜50% by volume, N,N-dimethylacetamide (DMAc) inanamount of 40%˜50%byvolume, and water in an amount of 2%˜8% by volume.

Acetonitrile and a phosphate buffer are employed herein as mobile phases.

Three parameters, including reaction temperature, reaction time and ratio of LMA to styrene, have to be considered during the polymerization of the monolithic columns, the tailing factor and resolution of the analytes are most likely to be affected by these parameters. According to the experimental design, the polymerization is performed at three levels of each parameter, wherein the reaction temperature is in a range of 0˜80° C. and the reaction time ranges from 1 hour to 24 hours. The tests shown in Table 2 below are carried out at a reaction temperature of 60° C., 65° C. and 70° C. for a reaction time of 5, 10, 15 hours in a LMA-to-styrene ratio of 50%, 75% and 100% by mole, respectively.

TABLE 2

| | Reaction | | | Tailing | Tailing | |
|---|---|---|---|---|---|---|
| Column | temperature | Reaction | LMA (mole | factor of | factor of | Resolution (PG |
| No. | (° C.) | time (h) | ratio, %) | BHA | BHT | and thiourea) |
| 1 | 60 | 5 | 100 | 0.79 | 1.24 | 1.45 |
| 2 | 60 | 10 | 75 | 0.92 | 3.06 | 2.46 |
| 3 | 60 | 15 | 50 | 1.05 | 1.62 | 0.00 |
| 4 | 65 | 5 | 50 | 1.17 | 3.33 | 4.28 |
| 5 | 65 | 10 | 75 | 0.54 | 1.97 | 2.60 |
| 6 | 65 | 15 | 100 | 0.88 | 1.18 | 1.31 |
| 7 | 70 | 5 | 75 | 1.14 | 2.00 | 3.57 |
| 8 | 70 | 10 | 100 | 0.64 | 1.29 | 1.20 |
| 9 | 70 | 15 | 50 | 0.96 | 2.68 | 4.46 |

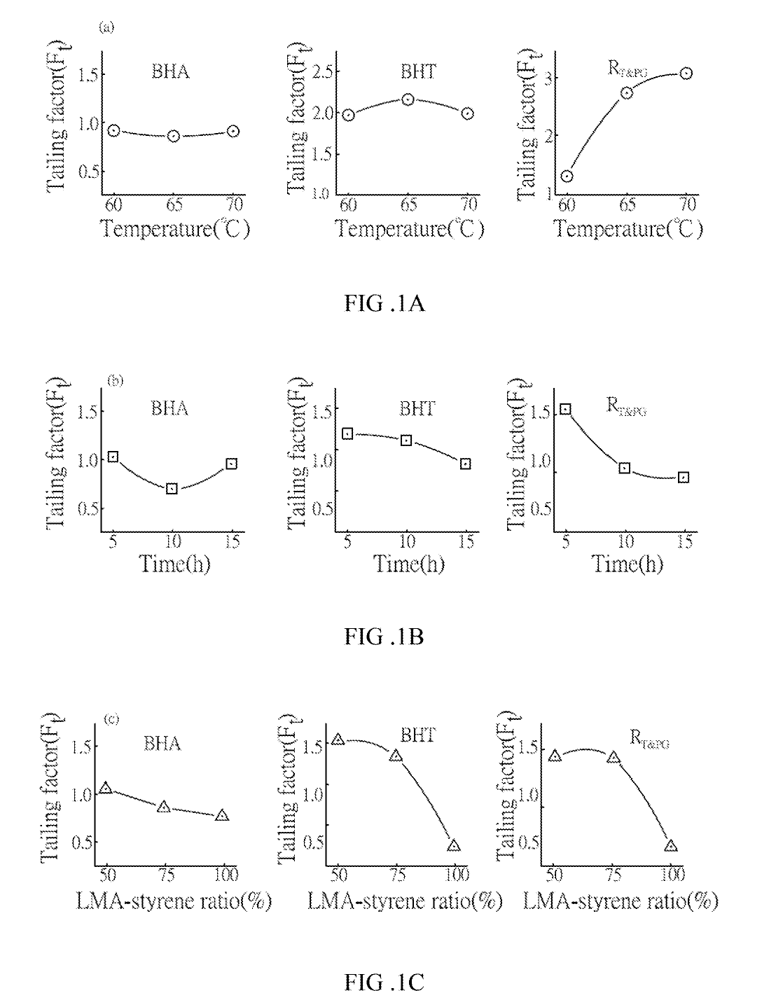

The effects of these parameters on the tailing factor and resolution of the analytes are shown in FIGS. 1A-C.

The results shown in FIGS. 1A-C indicate that the variation in reaction temperature does not cause significant difference in the tailing factor of BHT and BHA, but the resolution of thiourea and PG (R_{T&PG}) is optimized at a reaction temperature of 70° C. Furthermore, a longer reaction time (15 hours) is shown to improve the peak symmetry of BHT, while maintaining a satisfactory resolution for PG and thiourea. As to the LMA-styrene ratio (LMA:S), the best peak symmetry is achieved at 50 mole % LMA for BHA and 100 mole % LMA for BHT . It is therefore concluded that the optimum polymerization conditions are established with a reaction temperature of 70° C. and a reaction time of 15 hours.

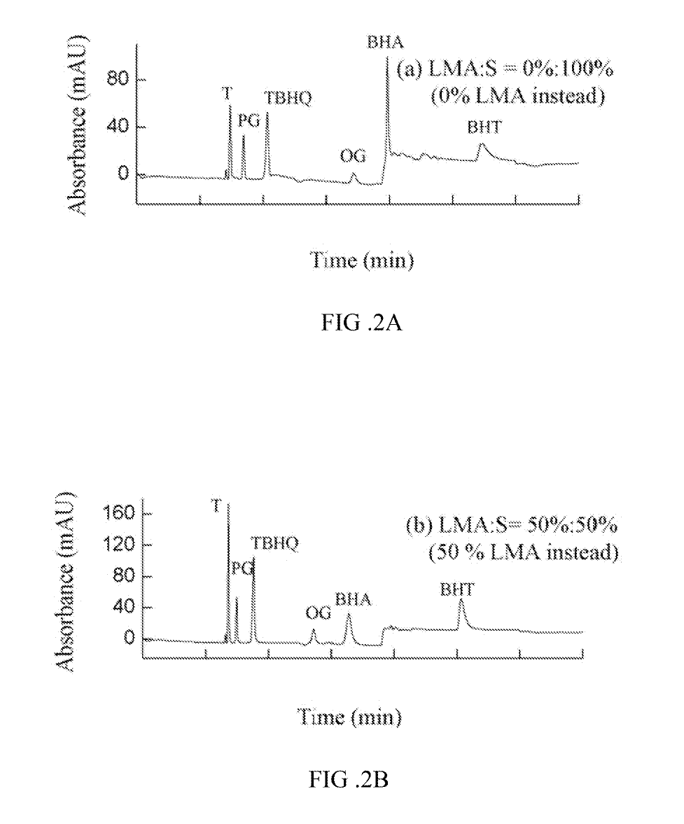

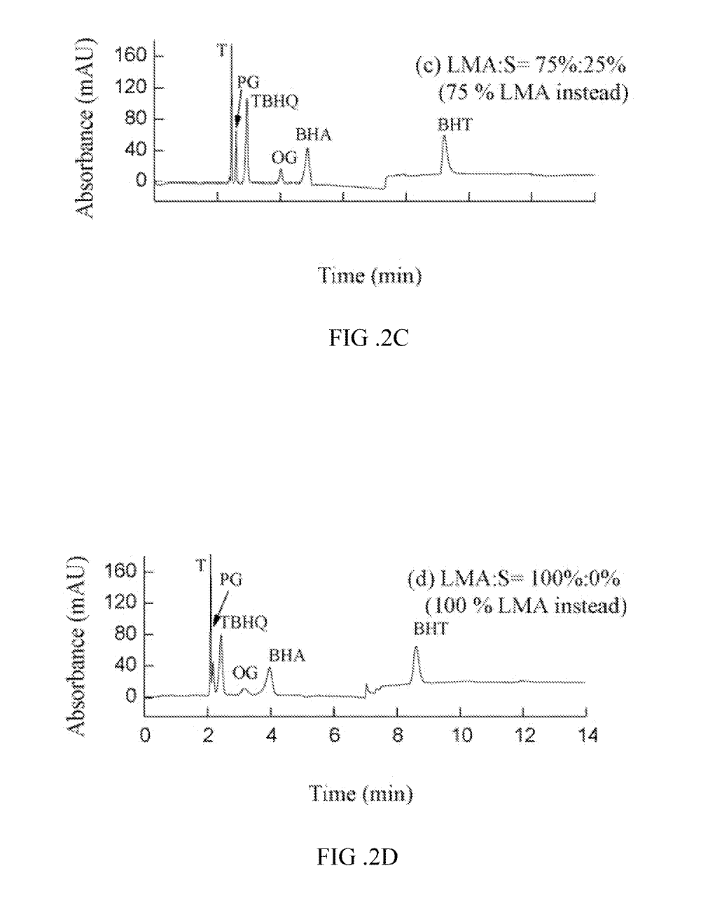

A monolithic column prepared above is placed in a CE instrument and is equilibrated with the mobile phase under 10 kV applied voltage and a 50 psi pressure at both ends of the column until a stable baseline is obtained. Samples and standards were electrokinetically injected into the capillary for 3 seconds at a voltage of 10 kV. An internal standard (100 μg/mL) is added into samples or standards, so as to improve the reproducibility of sample injection. Separation is achieved either with an isocratic elution or a two-step gradient elution process. Several solutions (composed of acetonitrile and a phosphate solution in different volume ratios from 55:45 to 85:15, pH 3.0) are used as mobile phases for isocratic elution. The two-step gradient elution is initiated with a mobile phase of 55% acetonitrile and 45% phosphate solution (v/v). It is switched to a mobile phase of 85% acetonitrile and 15% phosphate solution (v/v) at a time point of 4 or 5 minutes post-initiation of elution. Separation is carried out by applying a voltage of 20 kV, and the temperature of the capillary is maintained at 25° C., while 200nm or 214nm is selected as the detection wavelength. Thiourea is added as the EOF marker for determination of the EOF mobility and the retention factor of analytes. The results are shown in FIGS. 2A-D, where Absorbance (mAU) means the ratio of light absorbed by a given substance at a specified wavelength to that incident upon it, represented in milli-absorbance units, and T represents the EOF marker (thiourea).

As shown in FIGS. 2A-D, where (a)˜(d) denote Examples 1˜4, respectively, the analyte BHT exhibits a relatively strong retention on the stationary phase and shows significant peak-tailing in the case of Example 1. As the proportion of LMA in the monolithic column is increased to a level as used in Example 4, the retention time of BHT is reduced and the peak-tailing problem is improved, but the peak-overlapping problem occurs (such as the overlapping of the peaks for PG and TBHQ). The results suggest that the stationary phase composition disclosed herein (such as in Examples 2 and 3) does not only reduce separation time but also prevent the peak-overlapping and peak-tailing problems.

In addition, the effects of the respective stationary phase compositions of Examples 1˜4 on the tailing factor and resolution of the analytes are shown in Table 3 below:

TABLE 3

| | LMA (mole ratio, %) | | | | LMA (mole ratio, %) | | | |
|---|---|---|---|---|---|---|---|---|
| | Tailing factor | | | | Theoretical plate number | | | |
| Analyte | 0:100 | 50:50 | 75:25 | 100:0 | 0:100 | 50:50 | 75:25 | 100:0 |
| PG | 0.89 | 1.11 | 0.94 | — | 105000 | 153000 | 115000 | 52000 |
| TBHQ | 0.77 | 0.78 | 0.61 | 0.71 | 74000 | 81000 | 56000 | 16000 |
| OG | 1.5 | 0.96 | 0.85 | 0.98 | 57000 | 67000 | 49000 | 5000 |
| BHA | 1.6 | 0.96 | 0.55 | 0.51 | — | 46000 | 31000 | 10000 |
| BHT | 4.2 | 2.68 | 2.3 | 1.3 | 32000 | 90000 | 98000 | 56000 |

Table 3 indicates that the monolithic columns prepared with a LMA ratio of 50 mole % and 75 mole % lead to lower tailing factor for analytes, while a LMA ratio of 50 mole % results in a high theoretical plate number. The results suggest that the stationary phase composition disclosed herein provides excellent separation efficiency for antioxidants and is useful for preventing the peak-overlapping and peak-tailing problems.

### Embodiment 2

Benzophenones are useful in the manufacture of flavors, pharmaceuticals, perfumes and soaps. Some benzophenone derivatives are also found capable of absorbing ultraviolet light and suitable for protecting substances from damage caused by UV light. Such protection can be achieved by coating a benzophenone compound onto product surfaces or doping the benzophenone compound into products. For example, undercoats containing benzophenones are often employed to prime the surfaces of automobiles for anti-UV protection. Many popular sunscreens contain benzophenone derivatives as well. The most commonly used are 2,4-dihydroxybenzophenone, 2,2′,4,4′-tetrahydroxybenzophenone, 2-hydroxy-4-methoxybenzophenone, 4,4′-dimethoxybenzophenone, 2,2′-dihydroxy-4,4′-dimethoxybenzophenone, 4,4′-dihydroxybenzophenone. However, if a sunscreen contains an excess amount of benzophenones, it may cause adverse side effects on human body. This embodiment involves using benzophenone UV absorbers as test analytes, which are individually prepared by dissolving 0.04 g of each UV absorber standard (B1˜B10) in 20 mL acetonitrile to constitute a stock solution at a concentration of 2000 μg/mL. The stock solutions are diluted with acetonitrile to appropriate concentrations prior to use.

TABLE 4

| | | | | Porogenic solvent 76% (v/v) | | |
|---|---|---|---|---|---|---|
| | 24% (v/v) Monomer mixture | | | Cyclo- | | |
| | BMA | Styrene | DVB | hexanol | DMAc | Water |
| | % (v/v) | % (v/v) | % (v/v) | % (v/v) | % (v/v) | % (v/v) |
| Example 5 | 0 | 40 | 60 | 47.5 | 47.5 | 5 |
| Example 6 | 20 | 20 | 60 | 47.5 | 47.5 | 5 |
| Example 7 | 40 | 0 | 60 | 47.5 | 47.5 | 5 |

As shown in Table 4, monolithic columns are each manufactured using a monomer mixture in an amount of 24% by volume and a porogenic solvent in an amount of 76% by volume. The monomer mixture includes a styrene monomer in an amount of 0%˜40% by volume, a divinylbenzene (DVB) monomer in an amount of 50%˜80% by volume, and an acrylic monomer selected from butyl methacrylate (BMA), octyl methacrylate (OMA) and lauryl methacrylate (LMA) monomers in an amount of 0%˜40% by volume. Preferably, the acrylic monomer is butyl methacrylate (BMA). The porogenic solvent comprises cyclohexanol, N,N-dimethylacetamide (DMAc) and water. Acetonitrile and a phosphate buffer are employed as mobile phases.

In this embodiment, the inner wall of each capillary is similarly conditioned as described above. Then, monomer mixtures are prepared according to Examples 5˜7 listed in Table 4 and dissolved in the porogenic solvent. The resultant solutions are mixed with a charged monomer present in an amount of 2 wt %˜2.6 wt % based on the total weight of monomers (preferably, 0.0448 g vinylbenzenesulfonic acid, VBSA) and an initiator in an amount of 0.7 wt %˜0.9 wt % based on the total weight of monomers (preferably, 0.0155 g 2,2′-azobisisobutyronitrile, AIBN). Each of the mixtures thus obtained is sonicated for 15 minutes and then filled into a preconditioned capillary (having an overall length of 33 cm) to a length of 20 cm. After both ends of the capillary are sealed with an adhesive resin, the capillary is submerged in a 70° C. water bath for 5˜20 hours. An LC pump is used to wash the monolithic column first with methanol and then with the mobile phase.

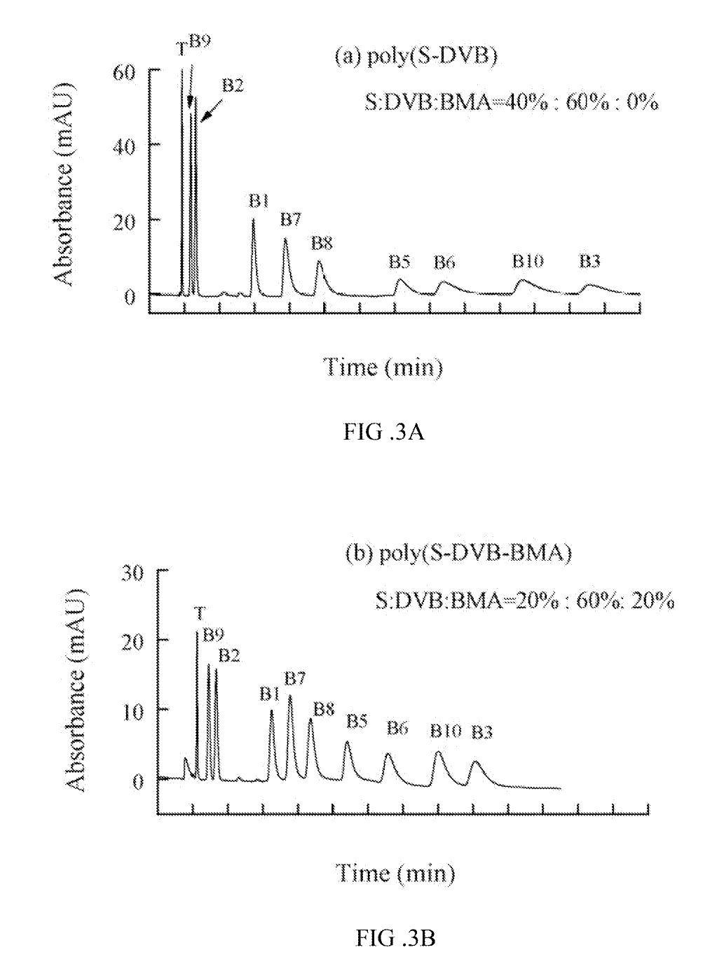

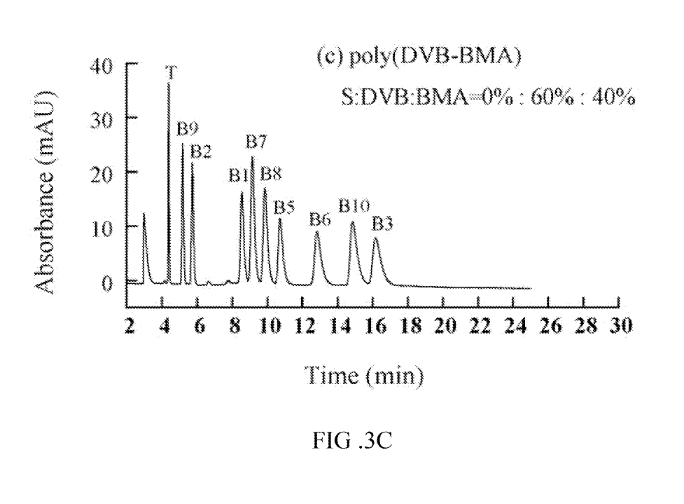

A monolithic column prepared above is placed in a CE instrument and is equilibrated with the mobile phase under 10 kV applied voltage and a 344.6 kPa pressure at both ends of the column until a stable baseline is obtained. Samples and standards were electrokinetically injected into the capillary for 3 seconds at a voltage of 10 kV. The separation process is carried out by applying a voltage of 20 kV, and the temperature of the capillary is maintained at 25° C., while 214 nm is selected as the detection wavelength and thiourea is added as the EOF marker. The results are shown in FIGS. 3A-C, where S:DVB: BMA represents the percent volume ratio of styrene: DVB: BMA.

As shown in FIGS. 3A-C, where (a)˜(c) denote Examples 5˜7, respectively, and the UV absorber standards are B1 (2,4-dihydroxybenzophenone), B2 (2,2′,4,4′-tetrahydroxybenzophenone), B3 (2-hydroxy-4-methoxybenzophenone), B5 (4,4′-dimethoxybenzophenone), B6 (2,2′-dihydroxy-4,4′-dimethoxybenzophenone), B7 (2,2′-dihydroxybenzophenone), B8 (2,2′-dihydroxy-4-methoxybenzophenone), B9 (4,4′-dihydroxybenzophenone) and B10 (2-hydroxybenzophenone), the analytes B3, B5, B6, B8 and B10 have relatively long retention times and show significant peak-tailing in the case of Example 1, while the peak of B2 overlaps with that of B9. As the proportion of BMA in the monolithic column is increased to a level as used in Example 6, the retention times of B3, B5, B6, B8 and B10 are slightly reduced, but the peak-tailing problem remains. The results suggest that the inventive stationary phase composition (Example 7) does not only reduce separation time but also prevent the peak-overlapping and peak-tailing problems.

It can tell from the experimental results above that when BMA-DVB is used in place of PS-DVB to prepare monolithic columns, the selectivity and separation efficiency of the monolithic columns with respect to the analytes are improved remarkably.

The effect of the molecular length of the alkyl moiety in alkyl methacrylate on chromatographic separation of benzophenone UV absorbers is further investigated.

As shown in Table 5, monolithic columns are each manufactured using a monomer mixture in an amount of 24% by volume and a porogenic solvent in an amount of 76% by volume. The monomer mixture may include a styrene monomer, a divinylbenzene (DVB) monomer, and an acrylic monomer selected from butyl methacrylate (BMA), octyl methacrylate (OMA) and lauryl methacrylate (LMA). The porogenic solvent comprises cyclohexanol, N,N-dimethylacetamide (DMAc) and water. Acetonitrile and a phosphate buffer are employed as mobile phases.

TABLE 5

| | | | | | | Porogenic solvent 76% (v/v) | | |
|---|---|---|---|---|---|---|---|---|
| | Monomer mixture 24% (v/v) | | | | | Cyclo- | | |
| | Styrene | BMA | OMA | LMA | DVB | hexanol | DMAc | Water |
| | % (v/v) | % (v/v) | % (v/v) | % (v/v) | % (v/v) | % (v/v) | % (v/v) | % (v/v) |
| Example 8 | 40 | 0 | 0 | 0 | 60 | 47.5 | 47.5 | 5 |
| Example 9 | 0 | 40 | 0 | 0 | 60 | 47.5 | 47.5 | 5 |
| Example 10 | 0 | 0 | 40 | 0 | 60 | 47.5 | 47.5 | 5 |
| Example 11 | 0 | 0 | 0 | 40 | 60 | 47.5 | 47.5 | 5 |

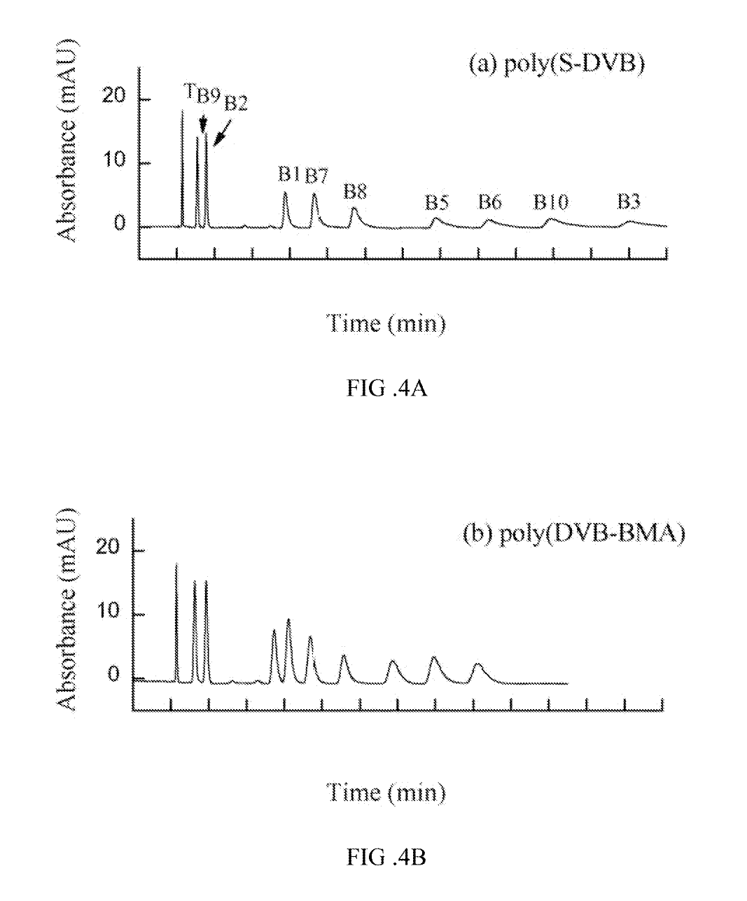

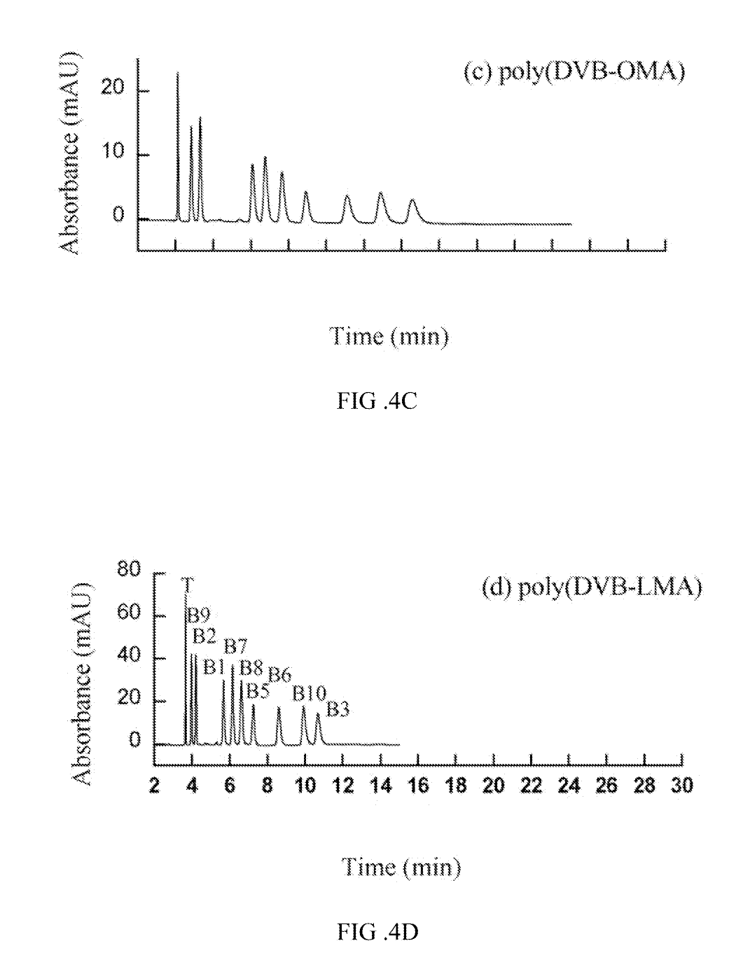

The results are shown in FIGS. 4A-D.

As shown in FIGS. 4A-D, where (a)˜(d) denote Examples 8˜11, respectively, the problems of peak-tailing and poor peak symmetry are observed with respect to B6, B10 and B3 compounds when the monolithic column prepared according to Example 9 is used to separate the nine benzophenones. However, the increase of the molecular length of the alkyl moiety (namely, increase in the length of the alkyl moiety of the acrylic monomer), leads to symmetrical signals, and no peak tailing is observed, according to the results obtained using the monolithic columns prepared according to Examples 10 and 11. The results indicate that, in the occasion where the same mobile phase is utilized, the absorbance peaks for the benzophenone analytes show smaller tailing factors and are more symmetrical in shape as the alkyl moiety of the acrylic monomer gets longer (see Table 6). In particular, the monolithic column prepared according to Example 11 provides a baseline separation of the nine benzophenone analytes within 11 minutes and shows two-fold enhancement in the analyte migration velocity over the column prepared according to Example 8.

TABLE 6

| | Tailing factor | | | |
|---|---|---|---|---|
| Analyte | Example 8 | Example 9 | Example 10 | Example 11 |
| B9 | 1.15 | 1.18 | 1.11 | 0.90 |
| B2 | 1.42 | 1.25 | 1.24 | 0.90 |
| B1 | 2.26 | 1.53 | 1.43 | 1.02 |
| B7 | 2.56 | 1.59 | 1.49 | 1.04 |
| B8 | 2.64 | 1.78 | 1.52 | 1.09 |
| B5 | 3.63 | 1.85 | 1.50 | 1.16 |
| B6 | 3.64 | 2.05 | 1.43 | 1.53 |
| B10 | 3.53 | 2.37 | 1.63 | 1.64 |
| B3 | 3.63 | 2.30 | 1.64 | 1.53 |

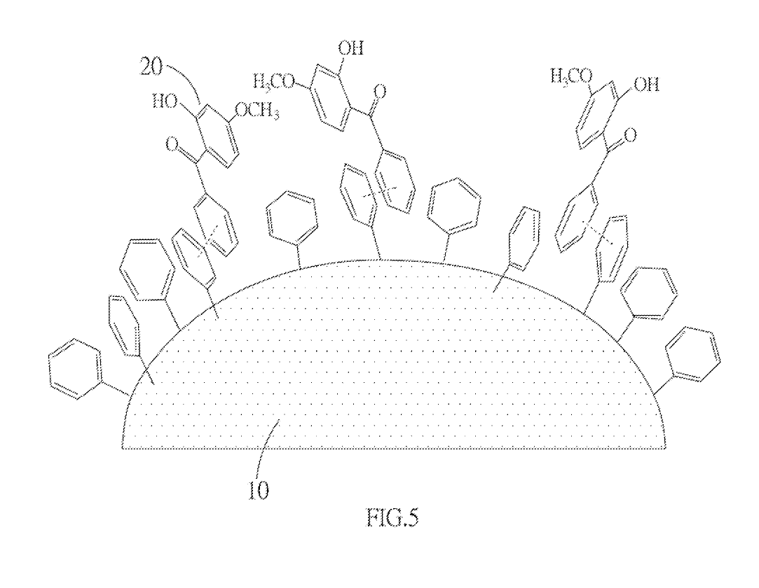

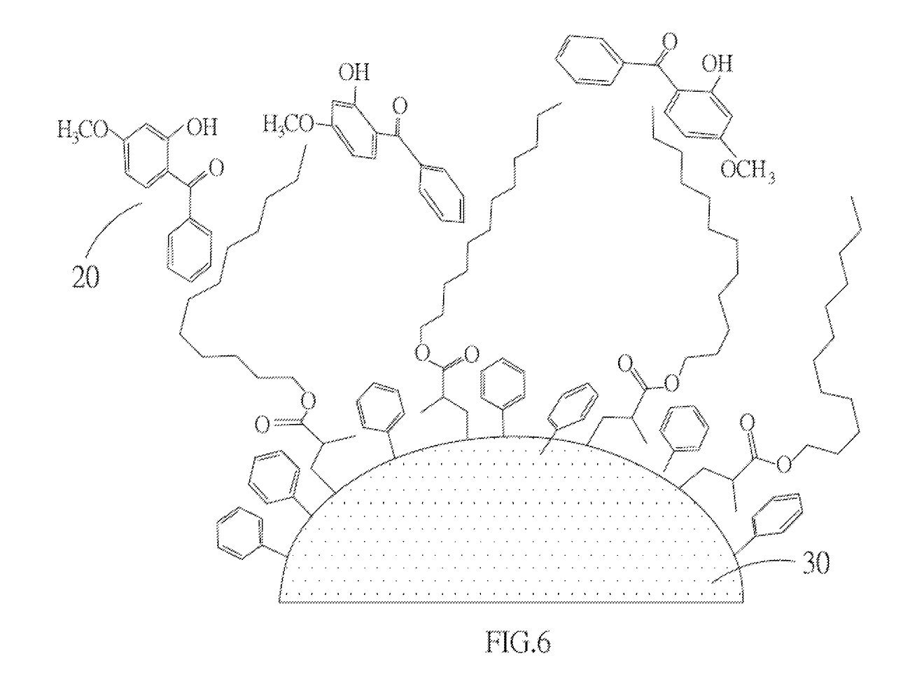

The results shown in FIGS. 4A-D suggest that the poly (S-DVB) column prepared according to Example 8 has a relatively plain surface and the separation effects thereof are mainly achieved mainly by virtue of the physical adsorption force of the analytes to the stationary phase and the molecular sieving effect created due to the micro-porosity of the stationary phase. As such, in the case where analytes are similar in structure and size and possess similar physical adsorption to the stationary phase, analytes 20 exhibit a strong π-π interaction with a poly (S-DVB) monolithic nodule 10 as depicted in FIG. 5, resulting in a decrease in separation efficiency. In contrast, a longer carbon chain pendant on the monolithic stationary phase, together with the molecular sieving activity possessed by the stationary phase, inhibit the analytes 20 from contact with the monolithic nodule as depicted in FIG. 6, thereby reducing the π-π interaction between benzene moieties. In addition, since all poly (divinylbenzene-alkyl methacrylate) columns are produced with the same moles of DVB and alkyl methacrylate monomer and their conversion yields are almost identical, the amount of benzene moieties carried on each monolithic surface should be similar to one another. Thus, the reason that causes the poly(DVB-LMA) columns 30 to provide a faster separation and better efficiency is not due to the reduction in hydrophobicity and the amount of benzene moieties. Therefore, the incorporation of BMA, OMA and LMA into the polymer-based monolithic stationary phase effectively reduces the retention and the partition of hydrophobic benzophenones on the stationary phase, whereby the time necessary for separating the analytes is reduced.

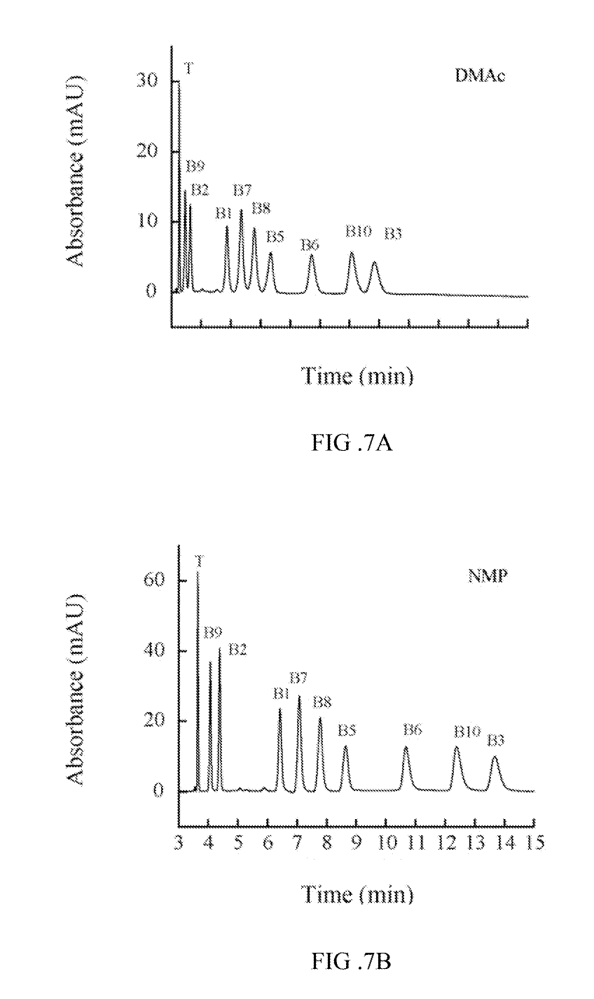

It is reported in literature that the nodule size and the porosity of a monolithic material are affected by the type of the porogenic solvent used to form the monolithic material. Therefore, the effect of the composition of the porogenic solvent on separation behaviors of the nine benzophenone analytes is examined in this embodiment. First, N-methyl-2-pyrrolidone (NMP) is used in place of DMAc as a component of the porogenic solvent for preparing LMA-DVB polymer-based monolithic stationary phase. Under the condition that the same mobile phase is utilized, the separation columns prepared by using two different porogenic solvent compositions (DMAc-cyclohexanol-water and NMP-cyclohexanol-water) are compared in terms of performance. As shown in FIGS. 7A-B, in the case where NMP is incorporated into the porogenic solvent, the resolutions for the analytes are significantly improved. Although the overall separation time for the analytes is slightly increased (from 11 minutes to 14 minutes), it can still provide a baseline separation for the analyte pairs B9 and B2, B7 and B8, and B10 and B3 (Rs=0.8, 1.19, 1.21). In spite of the 4-minute increase in separation time, NMP is still a more preferable component to be incorporated into the porogenic solvent as compared to DMAc, in view of separation efficiency.

### Embodiment 3

Non-steroidal anti-inflammatory drugs (NSAIDs) are widely used drugs with antipyretic and anti-inflammatory effects. In the past decade, NSAIDs are found to have potential for prevention of tumor growth. According to an investigation report regarding the drug subsidy reimbursed from the Bureau of National Health Insurance of Taiwan during 2000˜2001, the widespread use of NSAIDs has made the subsidy for the drugs acting on the nervous system on the top 20 list. Worse still, according to people's common behaviors of using drugs in this country, unused or expired drugs, including NSAIDs for sure, are often disposed of in garbage cans or dumpsters and finally become one of the major causes of contamination to water bodies and the entire environment. Pharmaceuticals, such as NSAIDs, and plasticizers, antibiotics and personal care products are considered as emerging contaminants suspected of being associated with endocrine disruption, including estrogenic effects in males and carcinogenicity.

Emerging contaminants are commonly characterized by not being regulated by the law for their maximum allowable levels, by being unprocessable by the municipal sewage treatment system, and by imposing a potential threat to human health or the environment. Since the European Union and Taiwan have not yet established enforceable health standards for emerging contaminants, and since vast quantities of NSAIDs are prescribed annually but not properly recycled, it is highly possible that they will cause serious contamination to the environment.

Therefore, this embodiment involves using the following NSAID standards as test analytes: Sulindac (SUL), Indoprofen (INP), Ketoprofen (KEP), Naproxen (NAP), Fenoprofen (FEP), Flurbiprofen (FLB), Ibuprofen (IBP), Indomethacin (IND) and Diclofenac sodium (DIC). The test analytes are individually prepared by placing 0.04 g of each NSAID standards in a flash vial and dissolving the same in 20 mL methanol to constitute a stock solution at a concentration of 2000 μg/mL. The stock solutions are diluted with methanol to appropriate concentrations prior to use.

A solution composed of monomers (DVB and SMA), porogenic solvents (water, cyclohexanol and NMP), a charged monomer (VBSA) and an initiator (AIBN) is used to prepare the polymeric columns. The polymerization procedure is optimized by univariate and multivariate approaches by varying four parameters, namely, the reaction temperature, the reaction time, the monomer-porogenic solvent ratio and the SMA-DVB ratio. It is found that the reaction temperature and the SMA-DVB ratio have the most significant effect on the NSAIDs separation. In this embodiment, the conditions of each of the four parameters are varied (i.e., the reaction temperature being of 50, 60 and 70° C. the reaction time being of 3, 7 and 15 hours, the monomer-porogenic solvent ratio being of 18/82%, 24/76% and 30/70%, and the SMA-DVB ratiobeingof 33/67%, 40/60% and 50/50%) either by the univariate or multivariate approach. In the univariate approach, only one parameter is changed for each column preparation, whereas two or three parameters are varied simultaneously in the multivariate approach. The optimal polymerization condition obtained by both approaches is the same as described below. 0.0155 g of AIBN (0.67%, w/v) and 0.0448 g of VBSA (1.93%, w/v) are dissolved in 2318 μL of a monomer mixture containing 40% SMA (v/v, 927 μL) and 60% DVB (v/v, 1391 μL). Ternary porogenic solvent, which consists of water (375 μL; 5%,v/v), cyclohexanol (4180 μL; 57%,v/v) and NMP (2787 μL; 38%, v/v), is slowly added to the monomer mixture. The solution is sonicated for 15 minutes until it became homogeneous, then it is filled into a preconditioned capillary (33 cm) to a total length of 20 cm. After both ends of the capillary are sealed with an adhesive resin, the capillary are submerged in a 70° C. water-bath for 3 hours. The monolithic column is then washed with methanol and mobile phase by an LC pump.

The multivariate approach described above is used herein. Table 7 shows the multivariate approach to column design, in which four parameters that are likely to have effect on the NSAIDs separation (reaction time, SMA-DVB ratio, monomer content and reaction temperature) are varied over three different levels. Nine columns are constructed according to the multivariate combination. Among the nine NSAIDs analytes described above, IND and DIC exhibit longest retention times and poorest resolution and, thus, are discussed in Table 7 below.

TABLE 7

| | Reaction | | Monomer | Reaction | resolution |
|---|---|---|---|---|---|
| Column | time | SMA:DVB | mixture | temperature | (IND, |
| No. | (hour) | (%:%)(v/v) | (v/v, %) | (° C.) | DIC) |
| 10 | 3 | 50:50 | 18 | 50 | 0 |
| 11 | 3 | 33:67 | 30 | 60 | 0 |
| 12 | 3 | 40:60 | 24 | 70 | 1.6 |
| 13 | 7 | 50:50 | 30 | 50 | 0 |
| 14 | 7 | 33:67 | 24 | 60 | 0 |
| 15 | 7 | 40:60 | 18 | 70 | 1.1 |
| 16 | 15 | 50:50 | 24 | 50 | 0 |
| 17 | 15 | 33:67 | 18 | 60 | 0 |
| 18 | 15 | 40:60 | 30 | 70 | 1.3 |

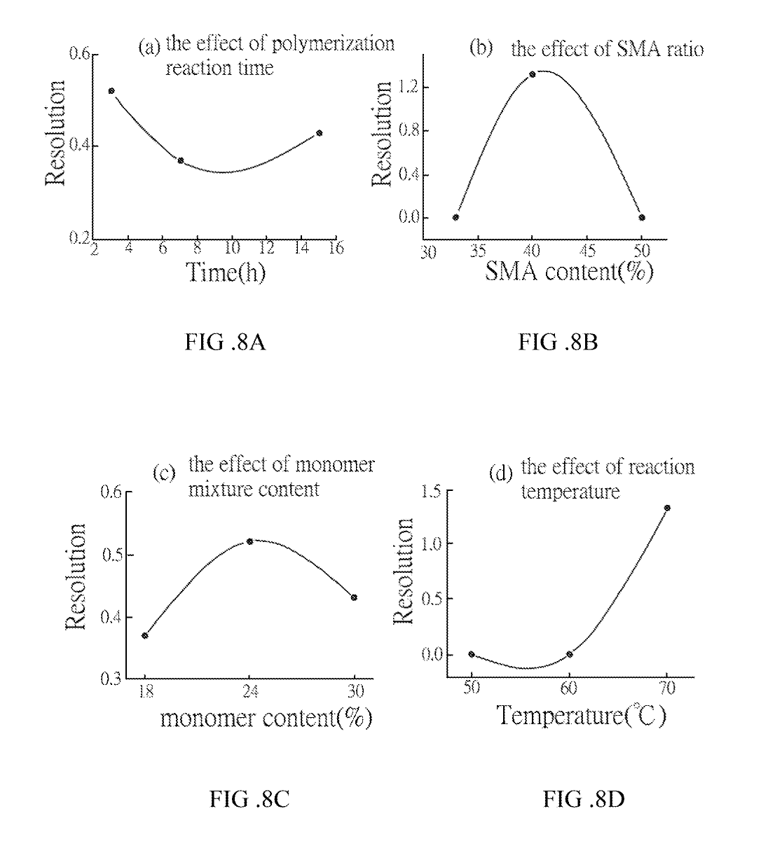

First, the effect of reaction time during polymerization on the analyte resolution is analyzed under the multivariate approach. The nine columns are divided into three groups, with each group having three columns prepared for the same reaction time. As shown in Table 7, the reaction times of 3, 7 and 15 hours result in average resolutions of 0.52, 0.37 and 0.43, respectively. It is therefore concluded that the optimum reaction time is 3 hours. The remaining three parameters are analyzed in the same manner. The results obtained are shown in FIGS. 8A-D.

In FIGS. 8A-D, the abscissa indicates the three levels of each parameter, whereas the ordinate indicates resolution. It can tell from FIGS. 8A-D that the optimum conditions are established with a reaction time of 3 hours, a ratio of SMA: DVB of 40%:60%, a monomer mixture content of 24% by volume and a reaction temperature of 70° C.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit of the invention and the scope thereof as defined in the appended claims.

What is claimed is:

1. A stationary phase composition for chromatographic separation, comprising:
a support material; and
at least a divinylbenzene group and an acrylic group are provided on the support material.

2. The stationary phase composition according to claim 1, wherein the support material is made of silicone material.

3. The stationary phase composition according to claim 1, wherein the support material is a capillary column.

4. The stationary phase composition according to claim 1, wherein the divinylbenzene group is selected from the group consisting of an ortho-divinylbenzene group and the derivatives thereof, a meta-divinylbenzene group and the derivatives thereof, a para-divinylbenzene group and the derivatives thereof, and a combination thereof.

5. The stationary phase composition according to claim 1, wherein the acrylic group is selected from the group consisting of an acrylate group and the derivatives thereof, and a methacrylate group and the derivates thereof, and a combination thereof.

6. The stationary phase composition according to claim 5, wherein the acrylic group is a methacrylate group.

7. The stationary phase composition according to claim 5, wherein the acrylic group has an alkyl moiety of at least 4 carbon atoms.

8. The stationary phase composition according to claim 7, wherein the acrylic group is selected from the group consisting of butyl methacrylate (BMA), octyl methacrylate (OMA), laurylmethacrylate (LMA), stearyl methacrylate (SMA) and a combination thereof.

9. The stationary phase composition according to claim 1, further comprising a styrene group provided on the support material.

10. The stationary phase composition according to claim 9, wherein the mole ratio of the acrylic group to the styrene group is ranged between 50:50 and 75:25.

11. A method of preparing a stationary phase for chromatographic separation, comprising the steps of:
(a) modifying a capillary column with a silane coupling agent having an acrylic group; and
(b) introducing a monomer mixture of a divinylbenzene monomer and an acrylic monomer and a solvent into the capillary column and allowing them to react under a predetermined reaction condition.

12. The method according to claim 11, wherein the monomer mixture further comprises a styrene monomer.

13. The method according to claim 12, wherein the mole ratio of the acrylic monomer to the styrene monomer is ranged between 50:50 and 75:25.

14. The method according to claim 11, wherein the acrylic monomer is selected from the group consisting of an acrylate monomer and the derivatives thereof, and a methacrylate monomer and the derivates thereof, and a combination thereof.

15. The method according to claim 12, wherein the acrylic monomer is selected from the group consisting of an acrylate monomer and the derivatives thereof, and a methacrylate monomer and the derivates thereof, and a combination thereof.

16. The method according to claim 14, wherein the acrylic monomer has an alkyl moiety of at least 4 carbon atoms.

17. The method according to claim 11, wherein the divinylbenzene monomer is selected from the group consisting of an ortho-divinylbenzene monomer and the derivatives thereof, a meta-divinylbenzene monomer and the derivatives thereof, a para-divinylbenzene monomer and the derivatives thereof, and a combination thereof.

18. The method according to claim 11, wherein the divinylbenzene monomer is selected from the group consisting of an ortho-divinylbenzene monomer and the derivatives thereof, a meta-divinylbenzene monomer and the derivatives thereof, a para-divinylbenzene monomer and the derivatives thereof, and a combination thereof.

19. The method according to claim 11, wherein the silane coupling agent is 3-(trimethoxysilyl)-1-propylmethacrylate (MSMA).

20. The method according to claim 11, wherein the step (b) comprises introducing the monomer mixture in an amount of 10%˜50% by volume and the solvent in an amount of 50%˜90% by volume.

21. The method according to claim 12, wherein the step (b) comprises introducing the monomer mixture in an amount of 10%˜50% by volume and the solvent in an amount of 50%˜90% by volume.

22. The method according to claim 21, wherein the monomer mixture comprises a styrene monomer in an amount of 0%˜40% by volume, a divinylbenzene (DVB) monomer in an amount of 50%˜80% by volume, and a methacrylate monomer in an amount of 0%˜50% by volume.

23. The method according to claim 22, wherein the methacrylate monomer is selected from the group consisting of a butyl methacrylate (BMA) monomer, an octyl methacrylate (OMA) monomer, a lauryl methacrylate (LMA) monomer, a stearyl methacrylate (SMA) monomer, and a combination thereof.

24. The method according to claim 22, wherein the monomer mixture comprises a styrene monomer in an amount of 20% by volume, a divinylbenzene (DVB) monomer in an amount of 60% by volume, and a lauryl methacrylate (LMA) monomer in an amount of 20% by volume.

25. The method according to claim 22, wherein the monomer mixture comprises a divinylbenzene (DVB) monomer in an amount of 60% by volume, and a butyl methacrylate (BMA) monomer or a lauryl methacrylate (LMA) monomer in an amount of 40% by volume.

26. The method according to claim 22, wherein the monomer mixture comprises a divinylbenzene (DVB) monomer in an amount of 60% by volume, and a stearyl methacrylate (SMA) monomer in an amount of 40% by volume.

27. The method according to claim 11, wherein the predetermined reaction condition comprises a reaction temperature of 0˜80° C. and a reaction time of 1˜24 hours.

28. The method according to claim 11, wherein the (b) further comprises introducing vinylbenzenesulfonic acid (VBSA) in an amount of 2.0 wt %˜2.6 wt % based on the total weight of the monomer mixture to serve as a charged monomer and 2,2′-azobisisobutyronitrile (AIBN) in an amount of 0.7 wt %˜0.9 wt % based on the total weight of monomers to server as an initiator.

29. The method according to claim 21, wherein the solvent comprises cyclohexanol, N,N-dimethylacetamide (DMAc), and water.

30. The method according to claim 29, wherein the solvent comprises cyclohexanol in an amount of 40%˜50% by volume, N, N-dimethylacetamide (DMAc) in an amount of 40%˜50% by volume, and water in an amount of 2%˜8% by volume.

31. The method according to claim 21, wherein the solvent comprisescyclohexanol,N-methyl-2-pyrrolidone (NMP), and water.

32. The method according to claim 31, wherein the solvent comprises cyclohexanol in an amount of 40%˜50% by volume, N-methyl-2-pyrrolidone (NMP) in an amount of 40%˜50% by volume, and water in an amount of 2%˜8% by volume.

33. The method according to claim 27, wherein the predetermined reaction condition comprises a reaction temperature of 50˜80° C. .

34. The method according to claim 11, wherein the solvent is a porogenic solvent.

35. The method according to claim 33, wherein the predetermined reaction condition comprises a reaction temperature of 70° C. and a reaction time of 15 hours.

36. The method according to claim 33, wherein the predetermined reaction condition comprises a reaction temperature of 70° C. and a reaction time of 3 hours.

37. The method according to claim 11, wherein the monomer mixture is in an amount of 18%˜30% by volume.

38. The method according to claim 37, wherein the monomer mixture is in an amount of 24% by volume.
